(19) United States
(12) Patent Application Publication
(10) Pub. No.: US 2013/0104363 A1
(43) Pub. Date: May 2, 2013

(54) THREADING DEVICE FOR USE WITH A SEATBELT AND A CAR CHILD SAFETY SEAT

(71) Applicant: Joan Allen, Raleigh, NC (US)

(72) Inventor: Joan Allen, Raleigh, NC (US)

(21) Appl. No.: 13/283,755

(22) Filed: Oct. 28, 2011

(51) Int. Cl. B25J 1/00; B23P 11/00

(52) U.S. Cl. 29/428; 294/26

(57) ABSTRACT

The present invention relates to a device for threading a seatbelt through a child's car seat. The threading device is light weight, and thus easy to use one-handed and consists of a handle, an elongated body, and a hook.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a device for threading a seat belt. In particular, the present invention relates to a device for threading a seat belt through a child safety seat.

2. Description of Related Art

The law requires a child being transported in a vehicle needs to be restrained in a child safety seat. The seat typically rests on the rear seat of the automobile where it is secured by threading one of the seatbelts intended for adults through holes adapted for the seatbelt in the back of the car seat. The seat is easy to place on the rear seat but the act of threading the seatbelt through the holes is difficult or impossible for many people. Because of that, many different approaches to threading devices for that purpose have been designed. All of them are difficult to use in their own right and relatively expensive to use for the short period of time a child safety seat is utilized. The devices are also relatively bulky and when not in use need to be stored. Even though such threading devices have been known since as early as 1999, there is still a need for a simple to use, inexpensive, and relatively compact threading device for use with a child's car seat that a person with arthritis or other problems can use.

### BRIEF SUMMARY OF THE INVENTION

The present invention provides a simple to manufacture and simple to use device for the purpose of threading a seatbelt through a child's seat.

Accordingly, one embodiment of the invention is a device for aiding a user in the threading of a car seatbelt's male end having an attachment locking hole in an end portion of the belt, through the at least two seatbelt securement holes in a child's car seat, the device comprising: a stiff wire body portion having a hook end and a handle end, the hook adapted for hooking through the attachment hole and the handle adapted for grasping with a single hand of the user wherein the length of the device body is adapted such that it is at least as long as the distance between the two farthest apart securement holes.

In another embodiment, the present invention relates to a method for aiding in the installation of a child's car seat on the seat of a car which utilizes the attachment of the car's seatbelt male end having an attachment locking hole in an end portion of the belt threaded through at least two securement holes for attaching the child's seat to the car's seat comprising:
a) positioning the child's seat on the car's seat near the seatbelt;
b) selecting a threading device comprising a stiff wire body portion having a hook end and a handle end, the hook adapted for hooking through the attachment hole and the handle adapted for grasping with a single hand of the user wherein the length of the device body is adapted such that it is at least as long as the distance between the two farthest apart securement holes;
c) threading the device through the securement holes of the of the seat by grasping the device by the handle and pushing the hook end through each of the securement holes;
d) hooking the hook end through the locking hole of the seatbelt;
e) bulling the device back out through the securement holes pulling the seatbelt along with the device till the end of the belt is pulled through all the securement holes; and
f) engaging the male end of the seatbelt with a female end of the seatbelt.

### BRIEF DESCRIPTION OF THE DRAWINGS

FIG. 1 is a side view of the device of the present invention.

FIG. 2 is a perspective view of the device hooking the male end of a seat belt.

FIG. 3 is a perspective view of the device of the invention threaded through two holes of a car seat and hooking the male end of a seatbelt.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

As used herein the term “about” refers to ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As noted above, car seats for use with infants and toddlers frequently have two or more holes for threading the car seatbelt through for locking the car seat in place. Car seat belts have a male end that has a hole in it, the male end being inserted in the female end of the seatbelt which also has a release button for disengaging the belt male end from the female end.

As used herein the phrases “stiff wire” or “plastic portion” refer to a wire or plastic that is sufficiently stiff and when hooked through the hole in the male portion of the seatbelt, is capable of pulling it through the holes in the car seat without bending and losing grip. Steel or other metal wires can be utilized and rigid polymers can also be used. One skilled in the art can determine both the gauge and stiffness required for this use. In one embodiment, the gauge of coat hanger wire is utilized. In another embodiment a molded plastic device is utilized.

The stiff wire or plastic is bent or shaped at one end into a hook end. The hook is designed to be able to fit the tip of the hooked end into the hole in the male end of a seatbelt to hook it for pulling purposes (this is shown in detail in the figures). The other end of the wire or plastic comprises a handle. The handle can be made by bending, molding, or shaping the wire or plastic into a handle shape as shown in the figures or could be mounted on a separate handle like insertion into a wooden handle, or welded to a metal handle, or the like. The handle is adapted to grasp with a single hand of the user. In one embodiment, the present invention can loop around the hand of the user such as shown in the figures. This embodiment allows those with arthritis or difficulty in holding a handle more ease in holding the device of the present invention. Those skilled in the art are capable of fashioning a handle at the end of the wire or plastic opposite the hook end. It is noted that the length of the wire is such that it is long enough to have the handle on one side while the device is run through the holes in the car seat and have the hook exposed on the opposite side a sufficient distance to engage the male end as described. In general, the present invention device is adapted such that it is at least as long as the distance between the two farthest apart securement holes of the car seat, such that the hook and handle protrude from the opposite sides. A minimum of about an inch clearance in one embodiment is made, but a longer amount would make a device that is useful with all different varieties of car seats. In one embodiment, the device will be about 18 to about 36 inches in length.

The present method of the invention involves a number of steps. The user of the car seat places the car seat in the car in the desired position between the two ends of a seatbelt. The threading device is picked up and the device threaded through the attachment holes of the car seat such that the hook sticks out the hole opposite where the device was inserted. The locking hole in the male end is then hooked with the hook end of the device (as shown in the figures) and the handle is pulled such that the male end is pulled through the securement holes and the male end of the seat belt inserted in the female end securing the car seat.

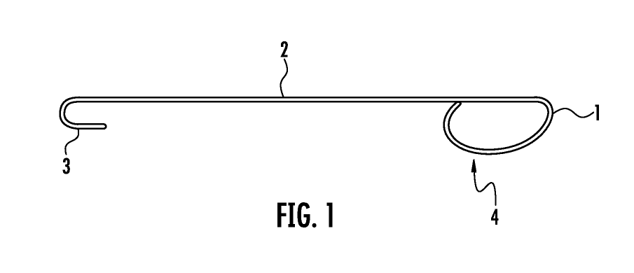

Now referring to the figures. FIG. 1 is a side view of a device 1 of the present invention. The device 1 consists of the stiff wire or plastic body 2 with a hook 3 and a handle 4 at the other end. In this embodiment the handle consists of the wire bent into a shape which can loop around the hand of the user such that the device is a single part. An add-on handle could also be utilized.

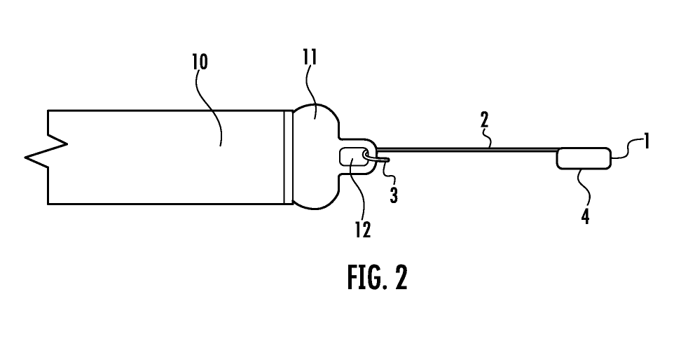

FIG. 2 shows the device 1 hooking a car seatbelt 10 having a male end 11 with a locking hole 12. The hook 3 has been inserted in hole 12 and when the handle 4 is pulled, the end of the seat belt 11 is pulled along with it. In this embodiment handle 4a is shown being a wooden or other molded type handle.

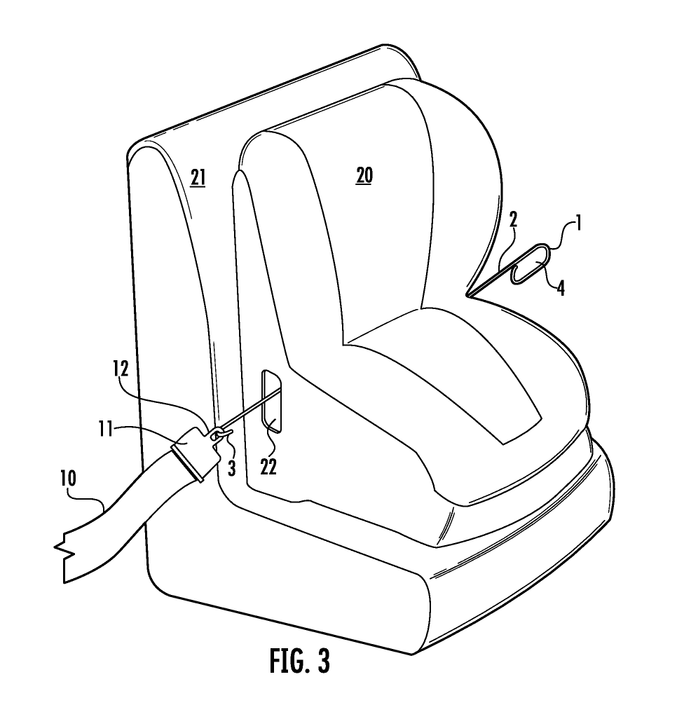

FIG. 3 shows a perspective view of the device 1 in use. A child's car seat 20 has been placed on a car's seat 21. This child's car seat 20 has two securement hole 22 (only one shown due to the perspective view). The device 1 has been threaded through the hole (not shown) and out the securement holes 22 that can be seen. The hook end 3 is hooking the male end as shown also in FIG. 2. The user of the device 1 then grasps the handle 4 (in this embodiment by sticking the hand in the loop) and pulls the device 1 back out through the securement holes 22. The male end can then be inserted in the female end securing the seatbelt and the child's car seat.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A device for aiding a user in the threading of a car seatbelt male end having an attachment locking hole in an end portion of the belt, through the at least two seatbelt securement holes in a child's car seat, the device comprising: a stiff wire or plastic body portion having hook end and a handle end, the hook adapted for hooking through the attachment hole and the handle adapted for grasping with a single hand of the user wherein the length of the device body is adapted such that it is at least as long as the distance between the two farthest apart securement holes.

2. A device according to claim 1 wherein the handle loops around the hand of the user.

3. A method for aiding in the installation of a child's car seat on the seat of a car which utilizes the attachment of the car's seatbelt male end having an attachment locking hole in an end portion of the belt threaded through at least two securement holes for attaching the child's seat to the car's seat comprising:
a) positioning the child's seat on the car's seat near the seatbelt;
b) selecting a threading device comprising a stiff wire or plastic body portion having a hook end and a handle end, the hook adapted for hooking through the attachment hole and the handle adapted for grasping with a single hand of the user wherein the length of the device body is adapted such that it is at least as long as the distance between the two farthest apart securement holes;
c) threading the device through the securement holes of the of the seat by grasping the device by the handle and pushing the hook end through each of the securement holes;
d) hooking the hook end through the locking hole of the seatbelt;
e) bulling the device back out through the securement holes pulling the seatbelt along with the device till the end of the belt is pulled through all the securement holes; and
f) engaging the male end of the seatbelt with a female end of the seatbelt.
